(19) United States
(12) Patent Application Publication
(10) Pub. No.: US 2003/0204754 A1
(43) Pub. Date: Oct. 30, 2003

(54) Controlling access to data stored on a storage device of a computer system

(75) Inventors: Daryl Carvis Cromer, Apex, NC (US); Richard Alan Dayan, Wake Forest, NC (US); Joseph Wayne Freeman, Raleigh, NC (US); Steven Dale Goodman, Raleigh, NC (US); Eric Richard Kern, Durham, NC (US); Randall Scott Springfield, Chapel Hill, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/133,895

(22) Filed: Apr. 26, 2002

(51) Int. Cl. G06F 12/14

(52) U.S. Cl. 713/202

(57) ABSTRACT

A designated user of a computer system is allowed to conceal from access portions of information stored on a hard disk drive or comparable storage device. The program instructions which initiate operation of the computer system, sometimes also known as BIOS code, enable a designated user or an administrator to declare certain portions of information normally stored accessibly to the system to be concealed, hidden, or invisible to a technical support person having a lesser level of access. Certain partitions are made inaccessible to any operator lacking the password of a designated user or administrator. Instead, a separate password is provided which enables initiation of operation of the system for maintenance purposes using only partitions which are open or unconcealed.

### RELATED PATENTS

The interested reader is referred, for assistance in understanding the inventions here described, to U.S. Pat. No. 5,388,156, issued Feb. 7, 1995, and U.S. Pat. No. 6,229,712, issued May 8, 2001, both held in common with the inventions here described. The referenced patents are relevant to the description which follows and are hereby incorporated by reference into this description as fully as if here repeated in full. Specific references to portions of the prior patents to which attention is directed follow in an effort toward brevity of the description here given.

### BACKGROUND OF THE INVENTION

Personal computer systems as described and shown, for example, in U.S. Pat. No. 5,388,156 beginning in Column 6 at line 33 and continuing through Column 8 at line 19 and related FIGS. 1 through 3 have been known and in use for some time. Configurations for such systems can vary from those shown in the '156 patent disclosure here incorporated by reference, as is known to persons of skill in the applicable arts and illustrated by other patent disclosures including the '712 patent disclosure beginning in Column 2 at line 24 and related FIGS. 1 through 3. The patents here referenced have been selected merely as being exemplary and due to ownership in common with the inventions here disclosed.

As evidenced by the referenced prior '156 patent, there have been concerns over the security of information stored in such computer systems, and steps have been taken to enable protection of such information. Conventionally, such protection is left to the selection and implementation of a system owner or a designated administrator for the system owner. In some instances, choices are made that information protection will not be enabled. In other instances, choices are made that information protection will be maximized.

In the latter instance, where protection of information is to be maximized, it remains necessary that maintenance of a computer system be performed from time to time. In at least some instances, such maintenance must be performed when the primary user of the system, here called the designated user (and who is a Normal User as defined in the referenced prior patent), is absent or unavailable to supervise the technical support person performing such maintenance. Should that occur, there is a significant risk, under prior practice, that information stored in the computer system may be compromised by becoming available to the technical support person through the level of access necessary to accomplish technical support. For example, a hard disk drive or other storage device connected to or forming a portion of the computer system and containing sensitive information may become accessible to the technical support person upon initiating system operation using a password such as those defined in the referenced '156 patent at Column 6 beginning at line 10.

### SUMMARY OF THE INVENTION

The present invention deems it desirable to enable a designated user of a computer system to conceal from access portions of information stored on a hard disk drive or comparable storage device. In realizing this purpose of the invention, the program instructions which initiate operation of the computer system, sometimes also known as BIOS code as described in the referenced '156 patent in Column 2 beginning at line 20, enables a designated user or an administrator to declare certain portions of information normally stored accessibly to the system to be concealed, hidden, or invisible to a technical support person having a lesser level of access. Conventionally, information stored in such a storage device can be and is divided into segments known as partitions. Stated differently, the present invention contemplates enabling certain partitions to be made inaccessible to any operator lacking the password of a designated user or administrator. Instead, a separate password is provided which enables initiation of operation of the system for maintenance purposes using only partitions which are open or unconcealed.

### BRIEF DESCRIPTION OF THE DRAWINGS

Some of the purposes of the invention having been stated, others will appear as the description proceeds, when taken in connection with the accompanying drawings, in which:

FIG. 1 is a representation of the partitions in an accessible, partitionable storage device in normal operation;

FIG. 2 is a representation of the partitions in an accessible, partitionable storage device in restricted mode operation; and

FIG. 3 is a representation of the sequence of actions in restricting access to declared partitions of an accessible, partitionable storage device.

### DESCRIPTION OF THE PREFERRED EMBODIMENT(S)

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

Briefly stated, the present invention encompasses configuring a computer system to have an accessible partitioned storage device and to distinguish among a requirement for entry of at least one password and no requirement for entry of a password and, in the event that entry of a password is required, between entry of a first password identifying a designated user and a second password identifying a technical support person. In the latter instance, the system is configured to respond to entry of the first password by enabling full access to partitions on the storage device and to entry of the second password by enabling access to a subset of the partitions on the storage device.

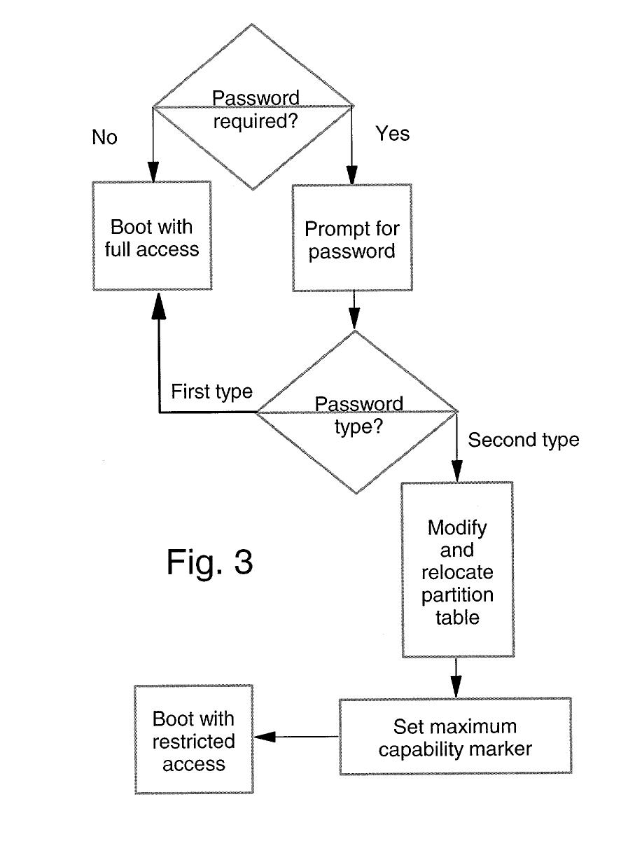

Specific illustrations of a computer systems and the elements of the system are here omitted, reliance being placed on the incorporations by reference set forth above. For purposes of the present discussion, it is contemplated by the present invention that the computer system implementing this invention have an accessible, partitionable storage device. Most usually, this device will be a magnetic media, rotating disk device of the type known as a hard drive and will be included within a common housing with other components of the system. However, it is known that the storage device may be optically based, or be based on a type of memory known as flash memory, and may be accessed through a network connection rather than being directly housed with in a common enclosure with the other components of the system. One example is illustrated at 19 in FIG. 3 of the '712 referenced patent.

The present invention contemplates that a designated user of a particular computer system may declare certain logical partitions on a partitioned storage device to be invisible to persons lacking proper authorization. Such partitions may contain sensitive information, such as information having significance for issues of national safety. The designated user, anticipated to be the principle user of the system, has a setup option in the program instructions which initiate operation of the computer system enabling establishment of a marker or pointer which declares a particular partition on the storage device to be the beginning of partitions which are to have restricted access. At the same time, or by action of an administrator, passwords are established which either allow access to all regular partitions of the storage device or restrict access to a subset of the partitions. The present invention contemplates that restricted access would permit initiation of operation of the system as may be appropriate or necessary for maintenance support of the system operation.

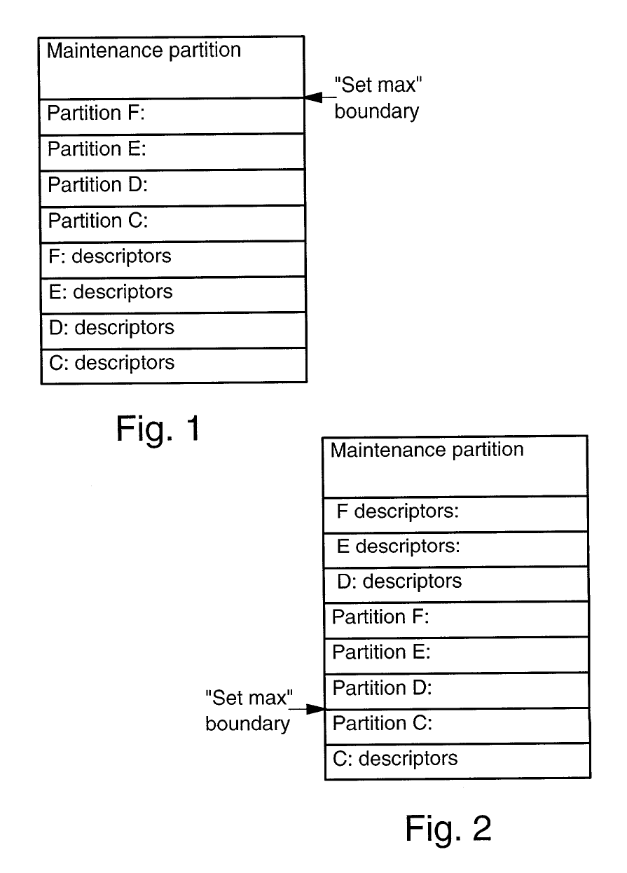

Referring now more particularly to FIG. 1, a schematic representation is there given of an accessible, partitioned, storage device functioning with a computer system in accordance with this invention. The storage capability of the device is indicated in a vertical bar graph, subdivided into partitions. From the bottom upward, the partitions are identified as C:, D:, E: and F:. Usual practice has the root or bootable partition C: designated as the active partition. The master boot record is found in the first record or sector of the storage device as is well known in the industry. A portion of the master boot record here specifically identified, for purposes to become more clear hereinafter, contains a partition table which has descriptors for each of the partitions, here identified as C: Descriptors, D: Descriptors; E: Descriptors; and F: Descriptors, respectively. As has become conventional, the storage device also has what is referred to as a Maintenance Partition which is normally concealed inaccessibly to a computer operator. The Maintenance Partition is other than a regular partition as that phrase is here used.

Conventionally, and as contemplated here, a root partition (commonly designated as Drive C:) contains those program instructions necessary and appropriate to bring the system into operation, such as an operating system or setup facilities which enable direction of operation to a particular source for an operating system. Thus, a service technician working with the system to perform maintenance tasks such as the replacement of a defective element or addition of a new functional capability may complete those tasks and confirm proper operation of the system using access to Drive C: only.

As contemplated by this invention, the BIOS or initiation program instructions has an option enabling an administrator or the designated user to declare that one particular partition is to be the starting partition for a set of partitions to which access is to be restricted. FIG. 2 illustrates the restriction in place. In the illustrated configuration and solely for purposes of illustration, the starting partition for restriction is D:. On making such a declaration, the establishing administrator or user is enabled to set passwords for the designated user and for other third party operators likely to be required to perform maintenance on the system. For purposes of description here, this second password may also be called a Service Access Password or SAP.

In operation, the BIOS will act after power on is confirmed to first determine whether any password protection has been set. If password protection has been enabled, then BIOS prompts the operator for a password. After a password is entered, BIOS will confirm the password and the type of password which has been supplied. See FIG. 3.

If the password of an administrator or the designated user has been entered, then BIOS performs a normal boot from the master boot record and makes all regular partitions (C: through F: in FIGS. 1 and 2) accessible to the user. A “set maximum capacity” pointer is set above the last of the regular partitions, F: in the example.

If, however, the SAP was entered, BIOS searches for the partition table, relocates those for the partition at which restriction is started and above to what will be a hidden portion of the storage device, and sets a “set maximum capacity” pointer to the boundary of the partition at which restriction starts. That is, in the illustrated example, at the boundary for partition D:. See FIG. 2. Partition table entries which would otherwise point to the restricted partitions are set to zero.

It should be noted that once the “set maximum capacity” command has been issued, the apparent size of the storage capability cannot be changed until the next system reset. On that next reset, if an administrator or designated user password is entered, BIOS restores the partition table from the hidden locations and operation continues.

These steps are schematically illustrated in FIG. 3.

As a consequence and in accordance with this invention, a technical service person entering a SAP will be able to cause the system to boot, or initiate operation, from the C: partition while access to partitions above the marker is restricted. The technical support person is thus given access to a subset of the partitions, while at the same time given access to those partitions which are necessary to confirm the proper operation of any corrective actions taken. Those actions may include replacement of a defective component or addition of an a new component.

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
a computer system;
a partitioned storage device accessible to said system and having at least two partitions designated as regular partitions; and
program instructions stored accessibly to said system and operable on powering on of the system to initiate system operation;
said program instructions enabling establishment of password protection for computer system functions;
said program instructions enabling establishment of a first password for a designated user and a second password for a technical support person other than the designated user;
said program instructions responding to entry of said first password by enabling full access to regular partitions on said storage device; and
said program instructions responding to entry of said second password by enabling restricted access to the regular partitions on said storage device.

2. Apparatus according to claim 1 wherein said storage device is a hard disk drive.

3. Apparatus according to claim 1 wherein said storage device has a root partition, and a master boot record stored in a first record of said storage device and having a partition table, and further wherein said program instructions response to entry of said second password includes modifying said partition table in said master boot record.

4. Apparatus according to claim 1 wherein said storage device has a root partition, and a master boot record stored in a first record of said storage device and having a partition table, and further wherein said program instructions response to entry of said second password includes relocating a portion of said partition table..

5. Apparatus according to claim 1 wherein said storage device has a root partition, and a master boot record stored in a first record of said storage device, and further wherein said program instructions response to entry of said second password includes setting a marker for maximum storage capability at a boundary between a partition to which access is granted and a partition to which access is restricted.

6. Apparatus comprising:
a computer system;
a partitioned hard drive included in said system and having at least two partitions designated as regular partitions;
said hard drive having a root partition and a master boot record stored in a first record of said hard drive and having a partition table; and
program instructions stored accessibly to said system and operable on powering on of the system to initiate system operation;
said program instructions enabling establishment of password protection for computer system functions;
said program instructions enabling establishment of a first password for a designated user and a second password for a technical support person other than the designated user;
said program instructions responding to entry of said first password by enabling full access to regular partitions on said hard drive device; and
said program instructions responding to entry of said second password by modifying said partition table in said master boot record and relocating portions thereof to restrict access to certain of the regular partitions on said hard drive.

7. A method comprising the steps of:
executing, in a computer system having an accessible partitioned storage device, program instructions effective on powering on of the system to initiate system operation;
distinguishing by execution of the program instructions between a requirement for entry of at least one password and no requirement for entry of a password;
prompting an operator of the system to enter a password by the execution of the program instructions in response to a determination that entry of a password is required;
distinguishing by execution of the program instructions in response to entry of a password between entry of a first password identifying a designated user and a second password identifying a technical support person;
enabling full access to partitions on the storage device by execution of the program instructions in response to entry of the first password; and
restricting access to a subset of the partitions on the storage device by execution of the program instructions in response to entry of the second password.

8. A method according to claim 7 wherein execution of the program instructions controls access to partitions in a hard drive.

9. A method according to claim 7 wherein execution of the program instructions accesses a master boot record in a first record of said storage device and further wherein said step of restricting access comprises modifying a partition table in the master boot record.

10. A method according to claim 7 wherein execution of the program instructions accesses a master boot record in a first record of said storage device and further wherein said step of restricting access comprises relocating a portion of a partition table in the master boot record.

11. A method according to claim 7 wherein said step of restricting access comprises setting a marker for maximum storage capability at a boundary between a partition to which access is granted and a partition to which access is restricted.

12. A method comprising the steps of:
executing, in a computer system having an accessible partitioned hard drive, program instructions effective on powering on of the system to initiate system operation;
distinguishing by execution of the program instructions between a requirement for entry of at least one password and no requirement for entry of a password;
prompting an operator of the system to enter a password by the execution of the program instructions in response to a determination that entry of a password is required;
distinguishing by execution of the program instructions in response to entry of a password between entry of a first password identifying a designated user and a second password identifying a technical support person;
enabling full access to regular partitions on the hard drive by execution of the program instructions in response to entry of the first password;
modifying a partition table in a master boot record and relocating a portion thereof by execution of the program instructions in response to entry of the second password and restricting access to a subset of the regular partitions on the hard drive; and
setting a marker for maximum storage capability at a boundary between a partition to which access is granted an a partition to which access is restricted.

13. Apparatus comprising:
a computer readable medium; and
program instructions stored on said medium accessibly to a computer system,
said program instructions when executing on a computer system:
distinguishing between a requirement for entry of at least one password and no requirement for entry of a password;
prompting an operator of the system to enter a password in response to a determination that entry of a password is required;
distinguishing in response to entry of a password between entry of a first password identifying a designated user and a second password identifying a technical support person;
enabling full access to partitions on an accessible partitioned storage device component of the system in response to entry of the first password; and
restricting access to a subset of the partitions on the storage device in response to entry of the second password.

14. Apparatus according to claim 13 wherein execution of the program instructions controls access to partitions in a hard drive.

15. Apparatus according to claim 13 wherein execution of the program instructions accesses a master boot record in a first record of said storage device and further wherein said step of restricting access comprises modifying a partition table in the master boot record.

16. Apparatus according to claim 13 wherein execution of the program instructions accesses a master boot record in a first record of said storage device and further wherein said step of restricting access comprises relocating a portion of a partition table in the master boot record.

17. Apparatus according to claim 13 wherein said step of restricting access comprises setting a marker for maximum storage capability at a boundary between a partition to which access is granted and a partition to which access is restricted.

18. A method comprising the steps of:
configuring a computer system to have an accessible partitioned storage device;
configuring the system to distinguish:
(a) between a requirement for entry of at least one password and no requirement for entry of a password and
(b) in the event that entry of a password is required, between entry of a first password identifying a designated user and a second password identifying a technical support person; and
configuring the system to respond:
(d) to entry of the first password by enabling full access to partitions on the storage device;
(e) to entry of the second password by enabling access to a subset of the partitions on the storage device.

19. A method according to claim 18 wherein the step of configuring the system to have an accessible partitioned storage device comprises configuring the system with a hard drive.

20. A method according to claim 18 wherein the step of configuring the system to respond to entry of the second password comprises preparing the system to access a master boot record in a first record of said storage device and modify a partition table in the master boot record.

21. A method according to claim 18 wherein the step of configuring the system to respond to entry of the second password comprises preparing the system to access a master boot record in a first record of said storage device and relocate a portion of a partition table in the master boot record.

22. A method according to claim 18 wherein the step of configuring the system to respond to entry of the second password comprises preparing the system to set a marker for maximum storage capability at a boundary between a partition to which access is granted and a partition to which access is restricted.
